(19) United States
(12) Patent Application Publication
(10) Pub. No.: US 2003/0134158 A1
(43) Pub. Date: Jul. 17, 2003

(54) Super battery module for mobile electronic apparatus

(75) Inventor: Chien Kung, Taipei (TW)

Correspondence Address: BRUCE H. TROXELL, SUITE 1404, 5205 LEESBURG PIKE, FALLS CHURCH, VA, 22041, US

(73) Assignee: Chien KUNG

(21) Appl. No.: 10/163,584

(22) Filed: Jun. 7, 2002

(30) Foreign Application Priority Data
Jan. 14, 2002 (TW) 091200205

(51) Int. Cl. H01M 2/00; H01M 10/42; H01M 16/00

(52) U.S. Cl. 429/7; 429/61; 429/9

(57) ABSTRACT

A super battery module is constructed to include a plurality of contacts connected to corresponding contacts of a mobile electronic apparatus for receiving external charging power or providing working power to the mobile electronic apparatus, a protection circuit module connected to the contacts to protect the super battery module against damage, a super capacity connected to the protection circuit module to provide a buffering effect so as to let the super battery module be charged by an external charging power under the protection of the protection circuit module and to absorb impact current during operation of the mobile electronic apparatus after the super battery module charged to the saturated status, and a battery cell connected to the protection circuit module and the super capacity for charging by an external charging power under the protection of the protection circuit module and for providing a working power to the mobile electronic apparatus when charged to the saturated status.

### BACKGROUND OF THE INVENTION

1. Field of the Invention

The present invention relates to a battery module for mobile electronic apparatus and, more specifically, to a super battery module containing a super capacity that provides a long stand-by time and long service life.

2. Description of Related Art

Following fast development of high technology, a variety of mobile electronic apparatus (mobile telephones, PDAs (personal digital assistant), notebook computers, and etc.) have been disclosed and have appeared on the market. These mobile electronic apparatus require a small battery module that provides a long stand-by time.

FIG. 1 is a circuit block diagram of a battery module according to the prior art. According to this design, the battery module 1 comprises a plurality of contacts 11, a protection circuit module 12, and a battery cell 13. The contacts 1 are adapted for coupling to the corresponding contacts of a mobile electronic apparatus (not shown) to receive charging power from the external power source or to provide battery power to the mobile electronic apparatus. The protection circuit module 12 is coupled to the contacts 11, and adapted for protecting the battery module against damage. The battery cell 13 is adapted to be charged under the protection of the circuit module and to provide battery power to the mobile electronic apparatus connected thereto when saturated.

FIG. 2 illustrates the variation of current of the prior art battery module during stand-by mode and off-hook mode. As illustrated, the battery module 1 provides power of stabilized 0.15A current to the mobile electronic apparatus, for example, mobile telephone connected thereto. When off-hook, the 0.15A power may be changed to a 0.54A impact current. This high current consumes a great amount of storage power (electric energy capacity) from the battery cell 13, shortening the stand-by time of the battery cell 13. Therefore, the user may need to prepare several battery modules for ready use.

### SUMMARY OF THE INVENTION

The present invention has been accomplished to provide a super battery module, which eliminates the aforesaid drawback. It is the main object of the present invention to provide a super battery module, which uses a super capacity to absorb impact current during the operation of the mobile electronic apparatus, enabling a stable current similar to that during the stand-by mode to be constantly provided. It is another object of the present invention to provide a super battery module, which has a long service life.

To achieve these and other objects of the present invention, the super battery module comprises a plurality of contacts connected to corresponding contacts of a mobile electronic apparatus for receiving external charging power or providing working power to the mobile electronic apparatus, a protection circuit module connected to the contacts to protect the super battery module against damage, a super capacity connected to the protection circuit module to provide a buffering effect so as to let the super battery module be charged by an external charging power under the protection of the protection circuit module and to absorb impact current during operation of the mobile electronic apparatus after the super battery module charged to the saturated status, and a battery cell connected to the protection circuit module and the super capacity for charging by an external charging power under the protection of the protection circuit module and for providing a working power to the mobile electronic apparatus when charged to the saturated status.

### BRIEF DESCRIPTION OF THE DRAWINGS

The present invention can be more fully understood by reference to the following detailed description and accompanying drawings, in which:

FIG. 1 is a circuit block diagram of a battery module according to the prior art;

FIG. 2 illustrates the variation of current of the prior art battery module during stand-by mode and off-hook mode;

FIG. 3 is a circuit block diagram of a super battery module according to the present invention; and

FIG. 4 is a circuit block diagram of the protection circuit module for the super battery module according to the present invention.

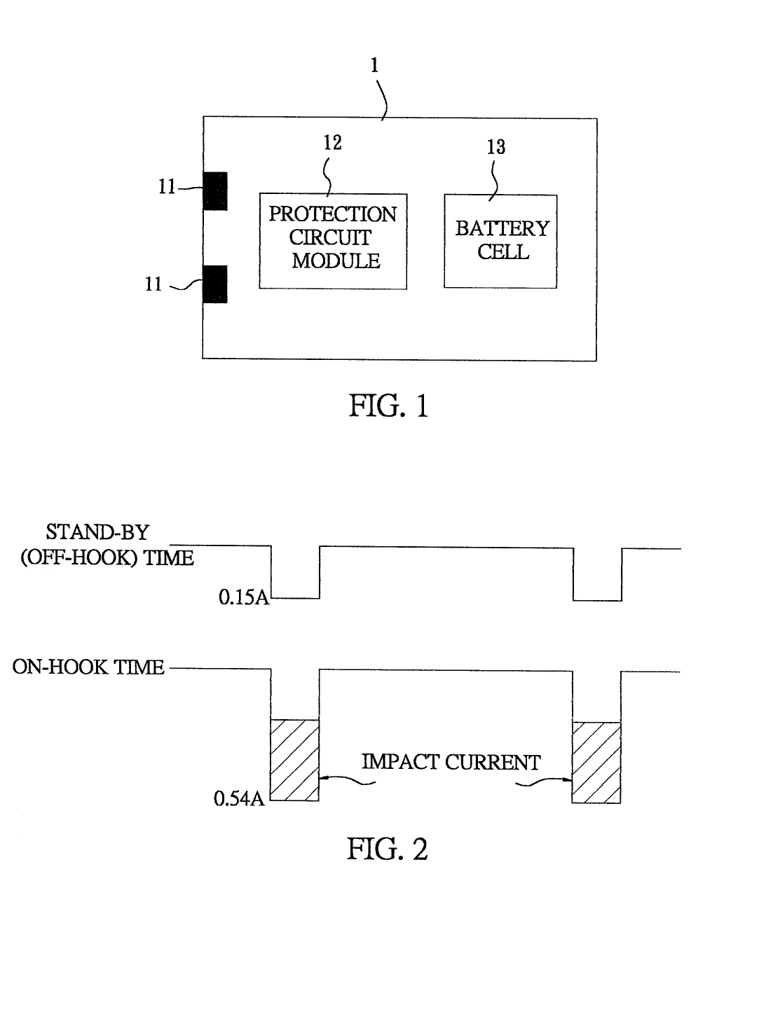

### DETAILED DESCRIPTION OF THE PREFERRED EMBODIMENTS

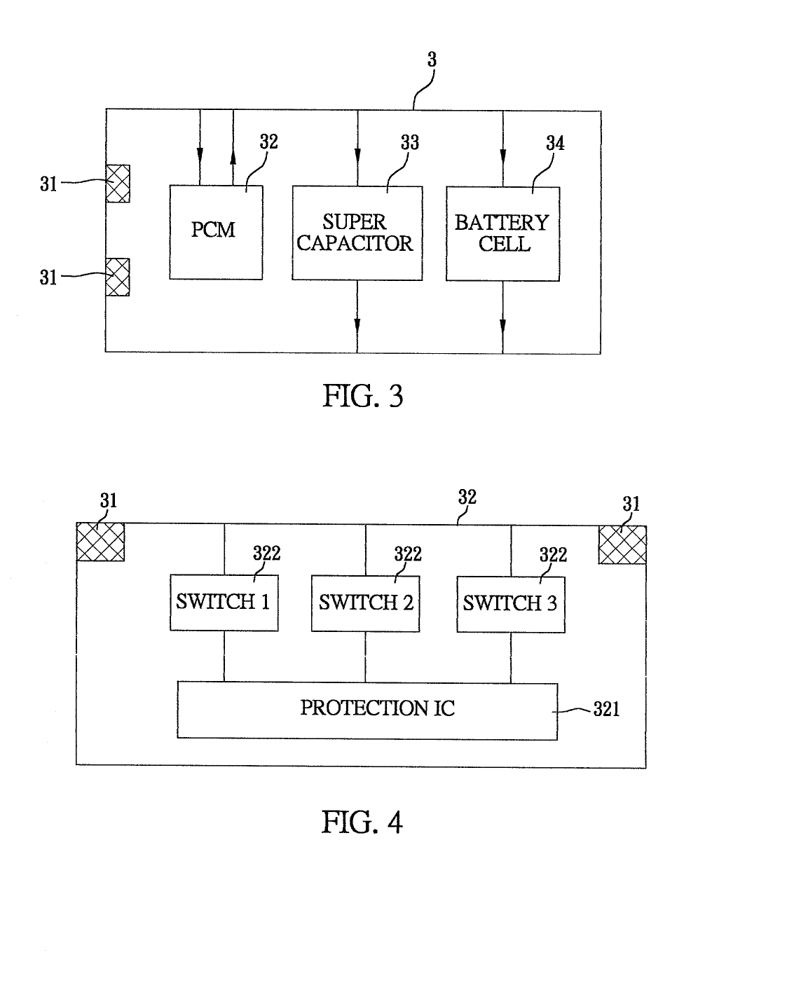

Referring to FIGS. 3 and 4, a. super battery module 3 in accordance with the present invention is shown comprising a plurality of contacts 31, a PCM (protection circuit module) 32, a SC (super capacitor) 33, and a battery cell 34.

The contacts 31 are coupled to the corresponding contacts of a mobile electronic apparatus to receive external charging power, or to provide working power to the mobile electronic apparatus. The PCM 32 is connected to the contacts 31 to protect the super battery module 3 against damage. The SC 33 is connected to the PCM 32 to provide a buffer effect, which enables the battery cell 34 to be charged under the protection of the PCM 32 and, absorbs impact current when the battery cell 34 charged to the saturated status. The battery cell 34 is connected to the PCM 32 and the SC 33, and adapted to receive external charging power under the protection of the PCM 32 or to provide working power to the mobile electronic apparatus connected thereto when charged to the saturated status. The super battery module is compatible to regular mobile telephones, PDAS, notebook computers, and any of a variety of mobile electronic apparatus.

The super battery module 3 comprises a super capacity 33 installed in the battery cell 34. In addition to the functioning similar to the charging discharging actions of a regular capacitor, the super capacity 33 provides a relatively greater buffering capacity but smaller volume. By means of adjusting the interface parameters among the PCM 32, the super capacitor 33, and the battery cell 34, the super capacitor 33 provides a function similar to a buffer to absorb impact current (the part of 0.54A that surpassed 0.15A) during the operation (off-hook mode) of the mobile electronic apparatus, enabling the battery cell 34 to provide 0.15A current same as the stand-by (on-hook) mode. Therefore, the super battery module 3 provides a stand-by time and service life much longer than conventional battery modules for mobile electronic apparatus.

Referring to FIG. 4, the PCM 32 comprises a protection IC 321 and a plurality of switches 322. According to this embodiment, the number of the switches 322 is 3. The switches 322 are respectively connected to the contacts 31. The protection IC 321 is connected to the switches 322. The switches 322 switch off the circuit subject to the status (overcurrent, overvoltage, or overheat) of the battery cell 34, protecting the super battery module 3 against damage.

A prototype of super battery module has been constructed with the features of FIGS. 3˜4. The super battery module functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A super battery module adapted for providing a working power to a mobile electronic apparatus connected thereto, comprising:
a plurality of contacts connected to corresponding contacts of the mobile electronic apparatus for receiving external charging power or providing working power to the mobile electronic apparatus;
a protection circuit module connected to said contacts to protect the super battery module against damage;
a super capacity connected to said protection circuit module to provide a buffering effect so as to let the super battery module be charged by an external charging power under the protection of said protection circuit module and to absorb impact current during operation of the mobile electronic apparatus after the super battery module charged to the saturated status; and
a battery cell connected to said protection circuit module and said super capacity for charging by an external charging power under the protection of said protection circuit module and for providing a working power to the mobile electronic apparatus when charged to the saturated status.

2. The super battery module as claimed in claim 1, wherein said protection circuit module comprises a plurality of switches respectively connected to said contacts, and a protection IC connected to said switches and adapted to control said switches to switch on/off the circuit connected between said contacts and said battery cell subject to the status of said battery cell.

3. The super battery module as claimed in claim 2, wherein said status of said battery cell includes an overcurrent status, an overvoltage status, and an overheat status.

4. The super battery module as claimed in claim 1, wherein said mobile electronic apparatus is a mobile telephone.

5. The super battery module as claimed in claim 1, wherein said mobile electronic apparatus is a PDA (personal digital assistant).

6. The super battery module as claimed in claim 1, wherein said mobile electronic apparatus is a notebook computer.
